(19) United States
(12) Patent Application Publication
(10) Pub. No.: US 2020/0025981 A1
(43) Pub. Date: Jan. 23, 2020

(54) CONTROL OF LIGHT SCATTERING WITH NANOPARTICLES AND/OR COATINGS

(71) Applicant: NANOCLEAR TECHNOLOGIES INC., Pasadena, CA (US)

(72) Inventors: Harold Frank GREER, PASADENA, CA (US); Ryan Morrow BRIGGS, PASADENA, CA (US); Sihan SHEN, PASADENA, CA (US); Scott S. HARRIED, PASADENA, CA (US); Tony LEE, PASADENA, CA (US); Raymond LOBATON, PASADENA, CA (US); Vahid MIRKHANI, PASADENA, CA (US)

(21) Appl. No.: 16/516,925

(22) Filed: Jul. 19, 2019

Related U.S. Application Data
(60) Provisional application No. 62/701,316, filed on Jul. 20, 2018.

(51) Int. Cl. G02B 5/02; G02B 5/20; G02B 5/00

(52) U.S. Cl. CPC G02B 5/0278; G02B 5/008; G02B 5/208

(57) ABSTRACT

The optical scattering response of a textured substrate is altered by the addition of one or more layers of nanoparticles and/or coatings. The nanoparticles and/or coatings have a refractive index that is comparable, or higher, than the refractive index of the substrate. The scattering cross section of the substrate is reduced by partially or completely filling gaps in the substrate. A material having a hazy appearance to visible light is therefore rendered more transparent by the addition of nanoparticles.

### CROSS-REFERENCE TO RELATED APPLICATIONS

The present application claims priority to U.S. Provisional Patent Application No. 62/701,316 filed on Jul. 20, 2018, entitled “Control of Light Scattering With Nanoparticles”, the contents of which are herein incorporated by reference in their entirety.

### TECHNICAL FIELD

The present disclosure relates to optical structures. More particularly, it relates to the control of light scattering with nanoparticles and/or coatings.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates exemplary features on a substrate.

FIG. 2 illustrates the difference in optical transmission between an etched glass substrate and a glass substrate without etching.

FIG. 3 illustrates an exemplary structure filled with nanoparticles.

FIGS. 4-5 illustrate scanning electron microscope (SEM) pictures of networked nanoparticles glued layers.

FIG. 6 illustrates two limiting cases of particles filling.

FIGS. 7-8 illustrate exemplary structures.

FIG. 9 illustrates a top-down view of randomly distributed scattering structures on a surface.

FIG. 10 illustrates the scattering cross section with no sidewall angle and no nanoparticles, and with 30 nm conformal nanoparticles.

FIG. 11 illustrates the factor of improvement in scattering cross section for FIG. 10.

FIG. 12 illustrates the scattering cross section with no sidewall angle and no nanoparticles, and with 60 nm conformal nanoparticles.

FIG. 13 illustrates the factor of improvement in scattering cross section for FIG. 12.

FIG. 14 illustrates the scattering cross section with no sidewall angle and no nanoparticles, and with 135 nm conformal nanoparticles.

FIG. 15 illustrates the factor of improvement in scattering cross section for FIG. 14.

FIG. 16 illustrates the scattering cross section with no sidewall angle and no nanoparticles, and with 300 nm conformal nanoparticles.

FIG. 17 illustrates the factor of improvement in scattering cross section for FIG. 16.

FIG. 18 illustrates the scattering cross section with no sidewall angle and no nanoparticles, and with 30 nm nanoparticles in a planar configuration.

FIG. 19 illustrates the factor of improvement in scattering cross section for FIG. 18.

FIG. 20 illustrates the scattering cross section with no sidewall angle and no nanoparticles, and with 60 nm nanoparticles in a planar configuration.

FIG. 21 illustrates the factor of improvement in scattering cross section for FIG. 20.

FIG. 22 illustrates an exemplary method to filling a substrate with nanoparticles.

FIG. 23 illustrates an exemplary flowchart of an etching method to fabricate structures on a substrate.

FIG. 24 illustrates a chemical structure for PFPA-C₁₁-PA.

FIG. 25 illustrates an exemplary SEM picture of substrate features with pits and with pits having pillars that protrude from the bottom of the pits.

FIG. 26 illustrates an exemplary zoomed out SEM picture of substrate features with pits and with pits having pillars that protrude from the bottom of the pits.

FIG. 27 illustrates an exemplary top-down SEM picture of substrate features with pits only.

### SUMMARY

In a first aspect of the disclosure, a structure is described, the structure comprising: a substrate transparent to electromagnetic radiation within a wavelength range, the substrate comprising a plurality of three dimensional structures and having a first refractive index; and a plurality of nanoparticles on the substrate, the plurality of nanoparticles having a second refractive index, wherein the plurality of nanoparticles is configured to reduce or to increase scattering of light transmitted through or from the substrate.

In a second aspect of the disclosure, a structure is described, the structure comprising: a substrate transparent to electromagnetic radiation within a wavelength range, the substrate comprising a plurality of three dimensional structures and having a first refractive index; and a coating on the substrate, the coating having a second refractive index or effective refractive index, wherein the coating is configured to reduce or to increase the scattering of light transmitted through or from the substrate.

In a third aspect of the disclosure, a method is described, the method comprising: providing a substrate transparent to electromagnetic radiation within a wavelength range, the substrate having a first refractive index; depositing a first plurality of nanoparticles on the substrate in a pattern; and etching a plurality of three dimensional scatterers on the substrate using the first plurality of nanoparticles as a mask.

In a fourth aspect of the disclosure, a method is described, the method comprising: providing a substrate transparent to electromagnetic radiation within a wavelength range, the substrate comprising a plurality of three dimensional scatterers and having a first refractive index; selecting a material for a first plurality of nanoparticles having a second refractive index, the second refractive index being equal to or higher than the first refractive index; and depositing at least one layer of the first plurality of nanoparticles on the substrate, the depositing comprising partial or complete filling of empty spaces in the substrate, thereby reducing or increasing scattering of the electromagnetic radiation.

### DETAILED DESCRIPTION

The present disclosure describes transparent materials comprising a substrate transparent to electromagnetic radiation, and one or more layers of particles. In some embodiments, the substrate can be made of glass or polymers and be transparent to visible light. The substrates comprise textures, such as pillars, which can be filled with the particles. In some embodiments, the refractive index of the particles is matched to that of the substrate in order to fabricate a composite material, comprising glass and particles, which has a higher transparency of the glass substrate alone. The composite material can also have additional properties such as superhydrophilia or superhydrophobia. In some embodiments, the composite material can be made tolerant to wear, retaining its superhydrophilic or superhydrophobic character even while being subject to wear, for example due to erosion over time.

In some embodiments, a networked composite can be deposited on a glass substrate according to the procedures described in the present disclosure. Three-dimensional features, such as nanopillars or micropillars, can be etched into the glass substrate. The pillars may be in a periodic configuration, thus forming an array, regions of local short range order, or they may be arranged in a disordered configuration. The pillars may have different shapes, such as cylindrical or pyramidal, or they have an irregular jagged profile, for example. These etched features may be pillars, pyramids, ovals, rings, or any three dimensional shape that protrudes from the surface. It will be understood by those skilled in the art that the inverse of these structures can be created as pits, as compared to the original starting surface. Further, it will be understood by those skilled in the art that these approaches can be combined together to have pillars that protrude from the bottom of the pits to a height that is less than, greater than, or equal to the height of the rim of the pit. Particles, such as nanoparticles (NPs) or microparticles, may be attached to the substrate, for example through chemical bonds, such as covalent, hydrogen bonding or ionic bonds through the use of functional groups, or they may be bonded through other adhesive methods, such as the use of an adhesive polymer. In some embodiments, the nanoparticles may be bonded to the substrate by: chemisorption, in particular covalent, hydrogen bonding or ionic bonds; adhesive polymers; adsorption, in particular van der Waals forces; mechanical interlocking of adjacent materials through a material that diffuses in the empty spaces of both surfaces; and interdiffusion of polymeric chains. These particles may be attached to these three dimensional features as well, coating the protruding structures up to and including filling the spaces between the structures. These particles may also partially or completely fill the pits that are formed by etching. The pits or features could be formed by plasma etching, wet chemical etching, carving or mechanical abrasion as well.

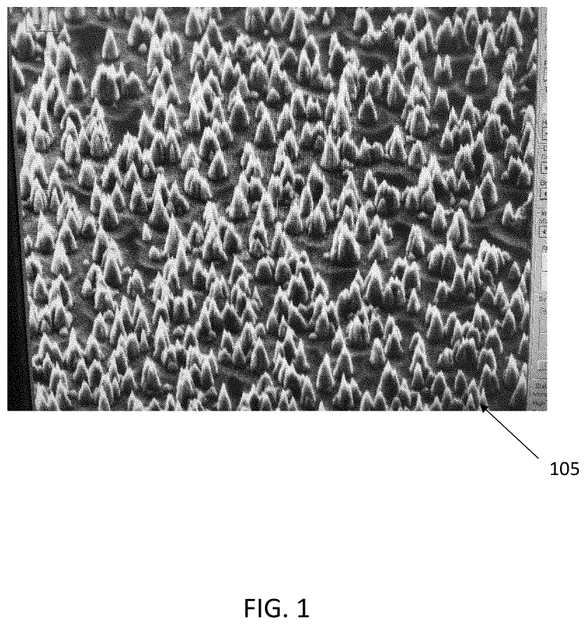

Glass or a similar optical material such as a polymer-based window film can be etched to produce deep features. For example, a soda lime glass substrate can be etched to produce features that are 2.5 microns tall, as illustrated in FIG. 1. This example comprises a plurality of irregular jagged shapes (105) having a conical outline.

In some embodiments, the etching is performed through an etch mask partially composed of 135 nm aluminum oxide nanoparticles (co-mixed with 30 nm silicon dioxide NPs in a 2:1 ratio) which are sprayed onto the glass surface. In other embodiments, differently sized particles may also be used, depending on the lateral dimensions of the features to be etched onto the glass. An inductively-coupled plasma, containing multiple gases such as SF₆, C₄F₈, or others, can be utilized to selectively etch the glass at a higher rate than the etching rate of aluminum oxide. In some embodiments, SF₆ can be utilized to control the shape of the profile of the features to be etched, for example conical (as in FIG. 1), having straight sidewalls or other shapes. The etching process can proceed until the entire aluminum oxide mask is etched away. Larger nanoparticles or ones made from chromium oxide or other materials can also be used to change the selectivity of the etching process and therefore its depth.

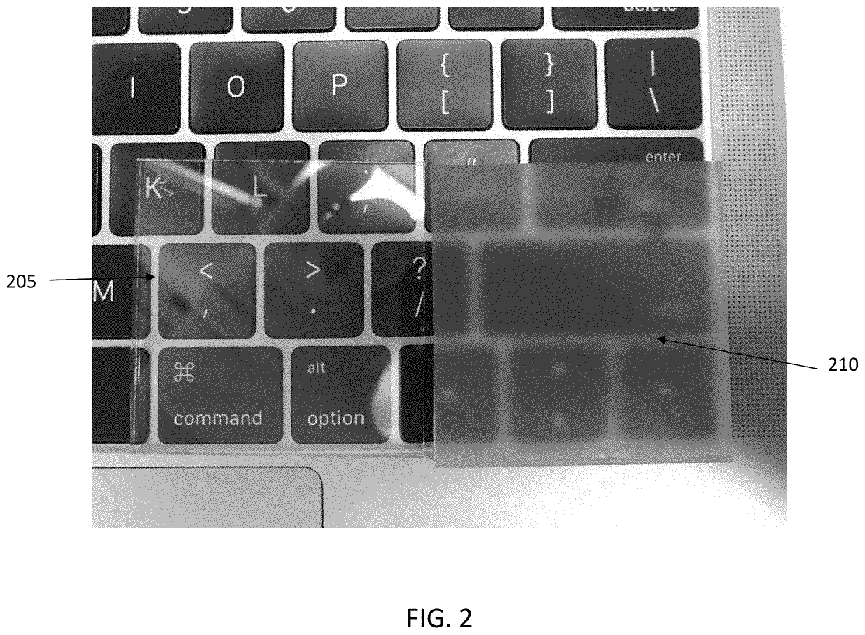

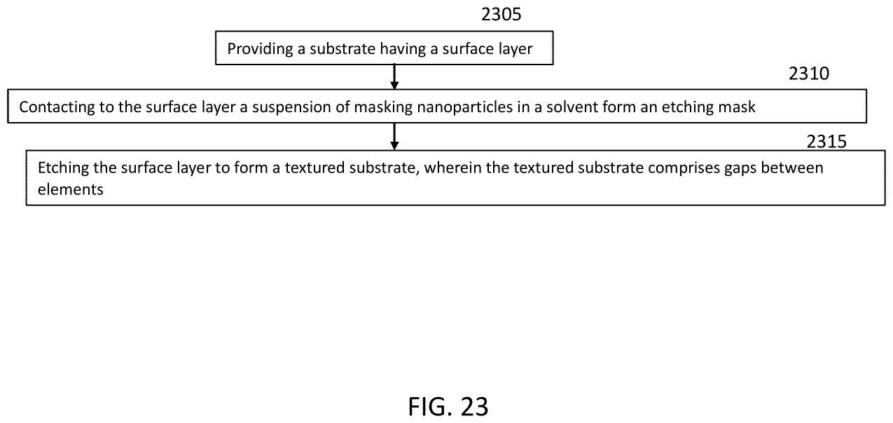

FIG. 2 illustrates the difference in optical transmission between an etched glass substrate (210) and a glass substrate without etching (205). The etching was carried out with a mask comprising 135 nm aluminum oxide and 30 nm silica nanoparticles in a 2:1 ratio. The substrate (210) is hazy due to the light being scattered by the large features etched on the surface. These features have lateral dimensions which are greater than the wavelength of visible light. FIG. 23 illustrates an exemplary flowchart of an etching method to fabricate structures on a substrate, as described above. A substrate is provided (2305), followed by dipping or spraying of the nanoparticles to form a mask (2310), and etching of the substrate (2315).

Once the high-aspect ratio features are etched, the nanoparticle gluing procedure can be utilized to backfill the etched structures. In other words, nanoparticles are deposited on the etched features, filling the empty space between features. The nanoparticles can be attached by a variety of means, for example using an adhesive polymer to cause the particles to adhere to the substrate and to other particles. One or more monolayers of particles may be deposited on the substrate.

In some embodiments, the nanoparticles used for filling the substrate are either index-matched to the substrate, or have a higher refractive index. The refractive index is chosen so that the particles are transparent to visible light. For example, SiO₂, AlN, Ta₂O₅, or TiO₂ can be used as a material choice for the particles. Some materials other than SiO₂ may require a thin shell of SiO₂ or other dielectric, metal, or organic material in order to be attached as described in the procedure below. Due to the refractive index choice and the filling of spaces between features on the substrate, the scattering from the etched structures is mitigated, because the critical feature size becomes smaller, and the index of refraction allows the effective medium inside the features to closely match the bulk material. In other words, the incident light would be scattered by the etched features, but the filling with the nanoparticles reduces the scattering due to the nanoparticles acting like a single solid material with an index of refraction comparable to the volumetric average of the void areas and the nanoparticles.

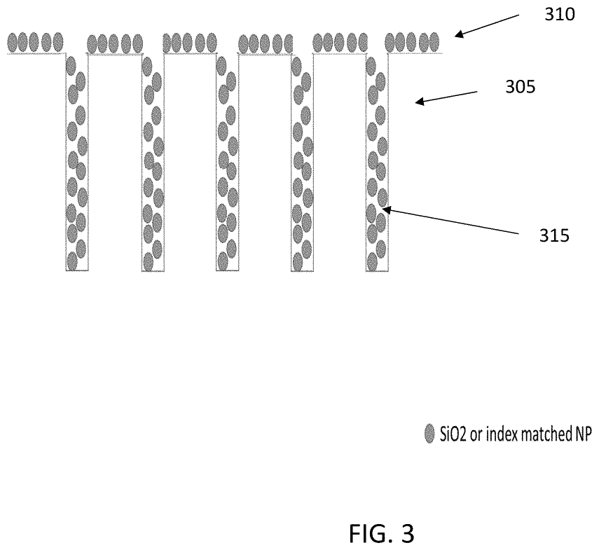

FIG. 3 illustrates an exemplary structure comprising etched features (305) having a high aspect ratio, with particles filling the spaces in-between (315) as well as above (310) the structure. In some embodiments, the particles may only fill the spaces in-between without covering the top of the features.

In order to make the substrate or substrate surface superhydrophobic or superhydrophilic, the nanoparticles can be chosen from inherently hydrophilic materials (e.g., SiO₂ and TiO₂) for superhydrophilicity, or can be coated with a fluorine-based polymer or other materials such as Teflon™ for hydrophobicity. The backfilled structure is wear tolerant because several microns of material can be removed in the direction perpendicular to the substrate surface and yet the periodicity of the surface feature is unchanged. For regular arrays of structures, the periodicity is the periodic spacing between adjacent elements. For irregular arrays of structures, the periodicity can be considered as an average spacing between adjacent elements.

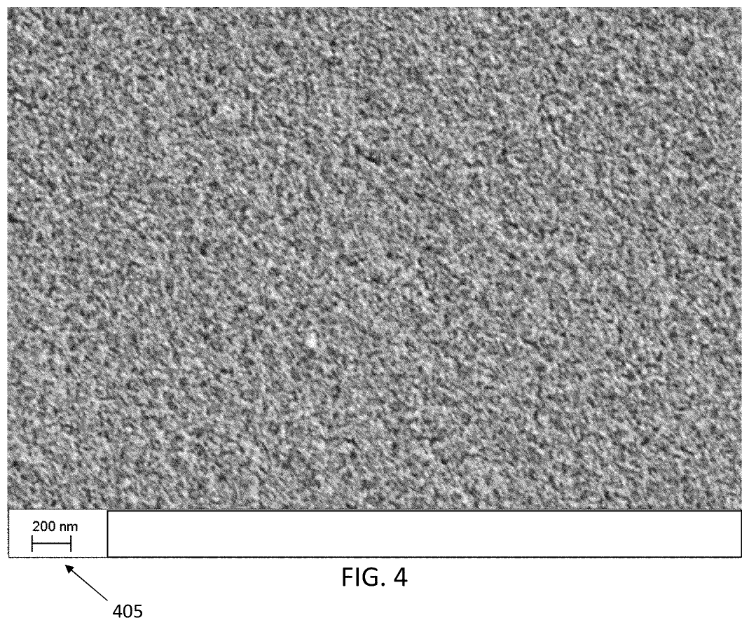

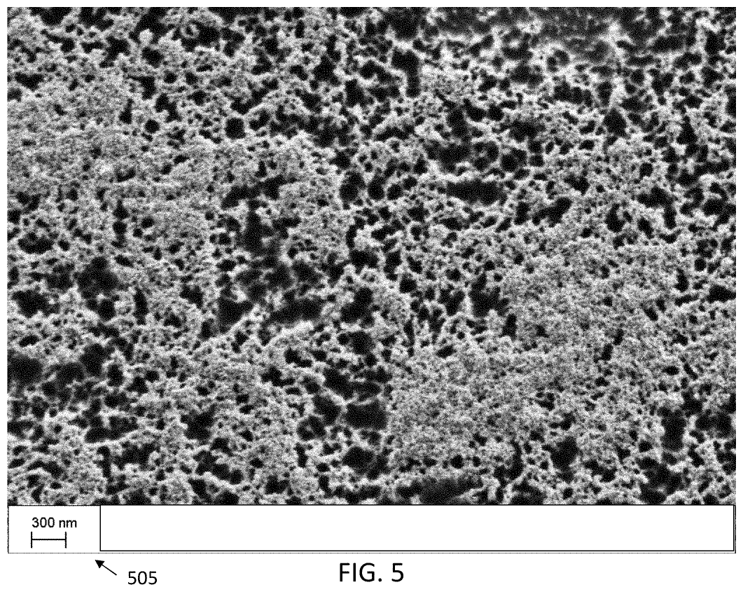

In some embodiments, it can be advantageous to glue the original nanoparticle mask, used to pattern the substrate material, to the substrate, to increase the overall strength of the composite material. That can be accomplished by putting a gluing polymer into the nanoparticle spray solution. An example can be cellulose derivatives. Scanning electron microscope (SEM) pictures of networked-nanoparticles glued layers are shown in FIGS. 4-5, for different scales. FIG. 4 has a 200 nm scale bar (405) and FIG. 5 has a 300 nm scale bar (505). The porosity of the glued layer (and therefore the optical and etching properties) can be controlled by tuning the glue type, the glue-to-nanoparticle ratio and number of spray passes, if the particles are sprayed. It can also be advantageous for the nanoparticles in the glue layer to be inherently superhydrophilic or superhydrophobic to impart additional or complementary functionalities to the nanoparticles glued into the features.

To prepare a networked or glued nanoparticles layer, a substrate may be prepared by a surface cleaning or activation step. For example, the surface may be activated with plasma (air, oxygen, nitrogen, argon), an etching solution (e.g. H₂SO₄, H₂O₂, and water), an alcohol based bath such as isopropyl alcohol mixed with KOH, or similar oxidizing agents. The nanoparticles are then sprayed using an ultrasonic spray coater with a controlled flowrate. The nanoparticle dispersion can contain surfactants and gluing agents.

For example, the following steps can be carried out:

(1) The substrate is cleaned and then exposed to oxygen plasma under the condition of 100 mTorr and 270 Volt DC bias for 1 minute.

(2) The glue-nanoparticle colloidal suspension can be prepared by:

(2.1) Adding 500 mg of 2-hydroxyethyl cellulose into 10 mL 29% ammonia hydroxide to form a yellowish solution.

(2.2) Adding 15 uL of tetraethyl orthosilicate (TEOS) into 100 mL of a 0.75 mg/mL 15 nm gamma phase Al₂O₃ suspension in 190 proof ethanol. Before TEOS is added in, the suspension is sonicated for 15 min and for 1 min after then.

(2.3) Adding 2.0 mL 29% ammonia hydroxide into the Al₂O₃/TEOS suspension in Step (2.2). The clear suspension turns to a lightly opaque appearance.

(2.4) Adding 1.0 mL 2-hydroxyethyl cellulose ammonia hydroxide solution in Step (2.1) into the Al₂O₃/TEOS suspension in Step (2.3), then sonicating for 5 min

(3) Spraying the colloidal suspension immediately for 6 passes

(4) Baking the sprayed samples at 45° C. overnight in the ambient air.

Several passes and a shaping gas at a sufficiently high pressure (e.g. 3 psi) can be used in order to ensure the entire substrate is covered by the nanoparticle coating.

There can be pauses between coating runs to ensure that the glue has the opportunity to cure, and prevent the nanoparticles from moving, which would create defects in the monolayers. The liquid in the dispersion is chosen to ensure that the mixture wets the substrate of interest well, without forming beading or “coffee rings” (coffee ring effect, CRE) once the droplets dry. Coffee rings are defined in this case as deposits of nanoparticles at the edges of dispersion droplets that form due to Marangoni or other type of flows, when droplets dry on surfaces. Marangoni flow is the mass transfer along an interface between two fluids, due to a gradient of the surface tension.

Certain elongated nanoparticles, such as TiO₂ nanorods, or other additives can be added to the mixture to also help prevent “coffee rings” formation. An exemplary fluid to be used for the dispersion can be 190-200 proof ethanol mixed with other liquids such as water or methyl ethyl ketone (MEK).

Other nanoparticles that can be used for this application are (but are not limited to): ZrO₂, Y₂O₃, AlN, or Ta₂O₅. These alternative nanoparticles may require a thin silicon dioxide shell in order to be used, to facilitate their binding. The essential features of these materials are that they are transparent to visible light, but have a higher refractive index than glass, to ensure that the effective refractive index of the textured glass with glued nanoparticles is close to that of the original native substrate. The substrate material, if not formed at least in part from silicon dioxide, may also require a thin silicon dioxide coating to facilitate binding of the nanoparticles. The SiO₂ layer can be chemically deposited from a precursor such as TEOS in a liquid phase or vapor deposited.

In addition to the manipulation of the visible transparency of the structure, the infrared (IR) transparency (or blocking) can be manipulated with the appropriate choice of plasmonic nanoparticles. Some examples of suitable materials are partially conductive, but transparent in the visible range, oxides such as antimony tin oxide, indium tin oxide, aluminum zinc oxide, or metals such as silver, gold, aluminum or other metallic elements. Care must be taken to reduce the interconnectivity of the conductive particles as there can be a shielding effect for longer wavelength radiation, such as cellphone signals, which could be preferable to let pass unobstructed. Particles can be selected for their ability to reflect or absorb these other frequencies.

In some embodiments, the following procedure can be carried out for the synthesis of Al₂O₃ nanoparticles with a SiO₂ shell and other SiO₂ shell nanoparticles. A nanoparticle shell refers to a silicon dioxide coating (continuous or discontinuous) that exceeds 1 Angstrom in thickness.

(1) 50 to 100 mg of Al₂O₃ nanoparticles were suspended in either ethanol or isopropanol (150 mL) in a round bottom flask with a stir bar.

(2) The flask was placed in an ultrasonic bath for 5 to 15 minutes prior to the addition of aqueous ammonia hydroxide (30%, 5 mL).

(3) A syringe was used to inject TEOS (tetraethyl orthosilicate, 400 microliters) in one portion to form a thick shell of SiO₂ as the reaction proceeds over 12-24 hours at room temperature.

Alternatively, a thinner shell of SiO₂ can be achieved by decreasing the volume amount of TEOS added to the NPs. The reactions were allowed to stir for the required time and then the solid was centrifuged to the bottom of a centrifuge tube. The NPs with a shell were resuspended in ethanol and subjected to ultrasonication for 5 minutes prior to centrifugation. The liquid ethanol was decanted away and the process was repeated several times to remove any chemicals from the nanoparticles. The isolated NPs may be placed in an oven overnight at 110 degrees Celsius to dry off any residual solvents.

In some embodiments, substrates can be made tolerant to wear, while yet retaining their superhydrophilic or superhydrophobic character, utilizing the following general fabrication process. The person of ordinary skill in the art will understand that variations of the following fabrication process may also be employed. A substrate is etched to create structures that protrude, or pits that are recessed, or both. Those structures themselves may or may not lead to inherent changes in the wettability of the substrate. The gaps between those structures or protrusions can be partially or completely filled by attaching or gluing or bonding nanoparticles in order to fill those gaps or re-enforce those protruding structures. These gaps or protrusions may be filled, partially filed, or coated with polymers, polymer blends, composites of nanoparticles and polymers, nanotubes, inorganic coatings or fillers, and organic coatings or fillers. These coatings may or may not have interactions with electromagnetic radiation and they may or may not change the wettability of the surface.

(1) A 0.1 to 1.0 percent solution of polyvinyl pyrrolidone (PVP), poly (2-vinyl pyridine) or poly (4-vinyl pyridine), can be prepared by dissolving PVP in 200 proof ethanol for a weight/weight percentage. For example, 650 mg of PVP can be added portion wise to 80 mL of ethanol, in a glass bottle with vigorous stirring through a stir bar. The solution is stirred until it becomes homogeneous and clear, which make take a few minutes or several hours.

(2) A freshly oxidized and textured soda-lime glass substrate is dipped into the PVP solution for at least 1 hour. In some embodiments, the substrate can be left in the solution overnight. After removal of the glass substrate from the ethanol and PVP solution, it can be rinsed with 200 proof ethanol to wash off loosely chemisorbed strands of polymer. Several mL of ethanol from a wash bottle can be used. In this way, a substrate is obtained comprising a glass substrate and a layer of PVP adhering to its surface. In other words, loosely attached polymer is rinsed off, leaving polymer that is more strongly attached to the glass surface.

(3) A 5 mg/mL colloidal suspension of SiO₂ nanoparticles is prepared and sonicated prior to use. The SiO₂ nanoparticles can be suspended in an ethanol concentrated mixture. A 10 mg/mL SiO₂ suspension in ethanol can also be used. The glass substrate is dipped in the nanoparticle suspension for at least 1 hour or more, or overnight. The substrate can then be rinsed with 200 proof ethanol, for example using a wash bottle and several mL of ethanol, to rinse off nanoparticles loosely attached to the substrate. In this way, a substrate is obtained comprising a glass substrate, a thin film layer of PVP adhering to its surface, and a layer of nanoparticles adhering to the polymer. In other words, loosely attached nanoparticles are rinsed off, leaving nanoparticles that are more strongly attached to the polymer. A layer of nanoparticles may comprise one or more monolayers of particles. These nanoparticles may be chosen from a large variety of compositions: dielectric particles, metals, etc. so long as a shell of silica or similar type of material that has affinity to PVP is chosen. This shell may be deposited using the TEOS based process described previously, or it may be deposited via vapor phase processes such as atomic layer deposition. In either method, the thickness of the shell on the nanoparticle may be independently specified to provide the desired attachment and optical/electromagnetic/heat properties that are desired.

(4) The substrate can then be dried with a N₂ flow and inspected by exposing it to moisture in the air and determine whether fogging occurs. For example, a breath test can be carried out to expose the substrate to moisture.

(5) In some embodiments, 200 proof ethanol is substituted with a solution of 2-butanone, also known as methyl ethyl ketone (MEK) and 20% 190 proof ethanol, made by mixing 80 mL MEK and 20 mL of 190 ethanol. The ethanol significantly improves the PVP, poly(4-vinyl pyridine, solubility in MEK. In some embodiments, PVP can be either poly (2-vinyl pyridine) or poly (4-vinyl pyridine). In other embodiments, other adhesive polymers may be used.

(6) In order to glue or adhere subsequent monolayers of nanoparticles, substrates can be given washed with 200 proof ethanol, for example using 200 mL, prior to entering an additional cycle of dipping in the PVP solution, and subsequently in the SiO₂ nanoparticles suspension. No further plasma oxidation was required to activate the surface and promote adhesion. Therefore, in some embodiments, the dipping in the polymer solution and in the nanoparticles solution creates one monolayer of nanoparticles attached to the glass by a thin layer of polymer. In some embodiments, each subsequent iteration of exposure to the polymer and to the nanoparticles allows an additional monolayer of nanoparticles to adhere to the substrate. Therefore, in some embodiments, it is possible to create a composite structure comprising a glass substrate with etched three-dimensional features, such as a regular or irregular array of nanopillars, followed by a multilayer structure comprising multiple layers of polymer and nanoparticles. The multilayer can comprise a first layer of polymer, followed by a first layer of nanoparticles, a second layer of polymer, a second layer of nanoparticles, and so on. In some embodiments, the iterative procedure can be stopped once the spaces between the nanopillars are filled. The pits or combination of pits and pillar like structures may be filled or partially filled in the same way.

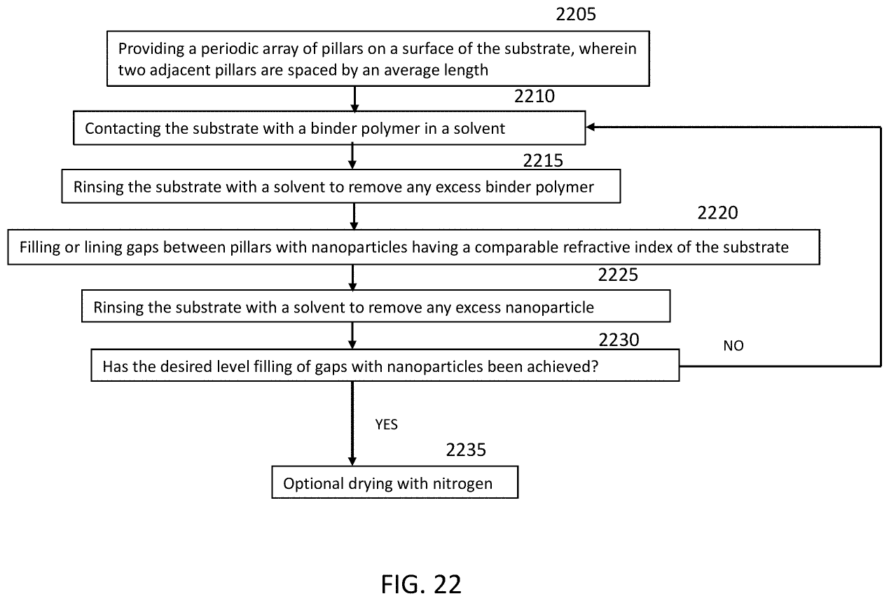

FIG. 22 illustrates an exemplary method to filling a substrate with nanoparticles, according to the fabrication protocol described above. A textured substrate is provided (2205), a gluing polymer is deposited (2210), any excess polymer is removed (2215), gaps are filled with nanoparticles (2220), excess nanoparticles are removed (2225), the process is either stopped or iterated (2230), and optionally the substrate is dried (2235) to complete the process.

In other embodiments, the nanoparticles can be made to adhere to the glass substrate without using an adhesive polymer, but by attaching a first functional group to the substrate, for example in gaseous or liquid form, and a second functional group to the nanoparticles, for example in a gaseous or liquid form. The first and second functional groups are chosen so as to form a covalent or ionic bond to each other. In this way, the nanoparticles are bonded to the glass substrate. One or more monolayers of particles can be attached by repeated exposure to the functional groups, with the difference that, for subsequent monolayers, the first functional group is attached to the pre-layered monolayer of nanoparticles instead of the glass substrate.

With reference, for example, to FIG. 3, in some embodiments the etched features do not need to be completely filled to observe a beneficial optical effect. A limiting case can be defined as conformal, comprising only a single perfect monolayer layer of nanoparticles, which would not fill completely the spacing between features on the substrate if the diameter of the nanoparticles is less than the spacing, or distance between adjacent features. Another limiting case can be defined as planar, comprising one or more layers of nanoparticles which completely fill the gaps between three-dimensional features. A structure can be fabricated for partial filling of the gaps, falling between the two limiting cases above.

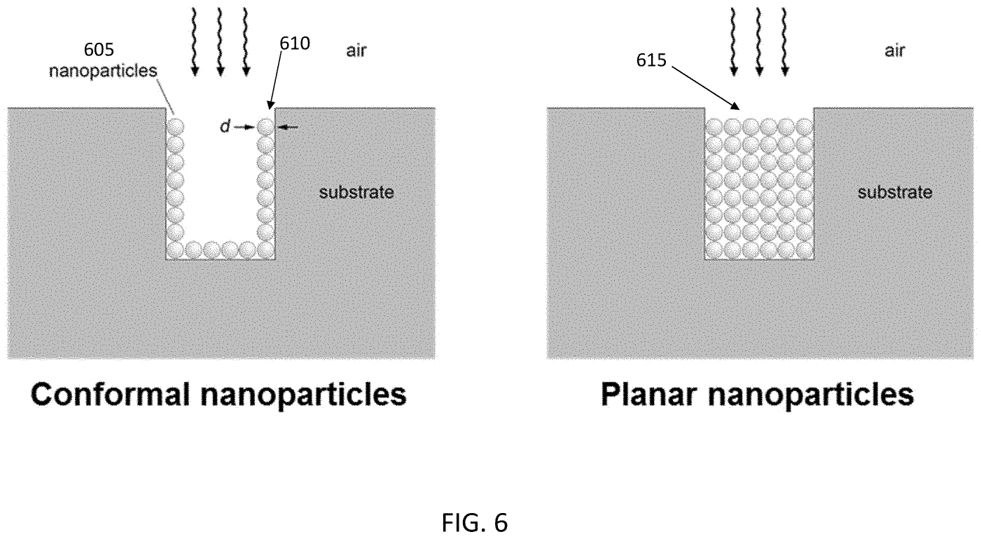

The two limiting cases of particles filling are illustrated in FIG. 6. In FIG. 6, the nanoparticles (605), having a diameter d (610) much smaller than the gap, are deposited in a conformal manner (605). Alternatively, in the planar case (615), the nanoparticles can fill the gap entirely. In other embodiments, the nanoparticles can partially fill the gap.

It can be noted from simulations that certain effects such as feature shape (sidewall angle), nanoparticle size to feature size (both width and height), and nanoparticle index of refraction have a significant effect on the optical impact of the nanoparticle filling. Simulation parameters are described in the following. The scattering in the model is calculated based on holes in a material, but the concepts derived here also apply in the limiting case where the holes intersect and the substrate appears to be an array of isolated pillars.

Scattering cross sections, a, were calculated for isolated, radially symmetric, etched structures with and without nanoparticles, using full-field three-dimensional FDTD simulations. The scattering structures were defined by: width (diameter), w; height, h; and either no sidewall angle (forming a cylinder) or a non-zero sidewall angle, p (forming a truncated cone). Sidewall angles of 10° and 20° were considered in the simulations. However, other angles may be used during fabrication. The width was varied from 100 to 500 nm, and the height was varied from 200 to 2000 nm. Narrow structures with a sidewall angle can have a maximum height. The substrate is assumed to have a refractive index of ˜1.5 (e.g. glass or plastic), and the incident light is a plane wave covering wavelengths from 250 to 1550 nm. The above numerical parameters can be used, in some embodiments, to fabricate the structures.

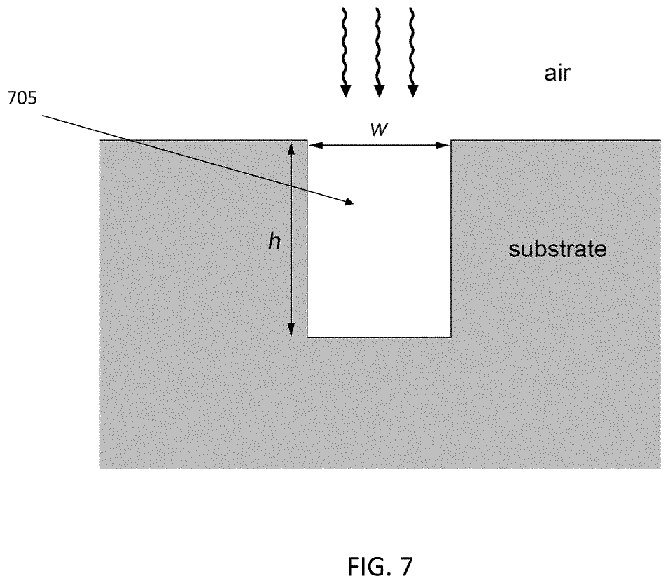

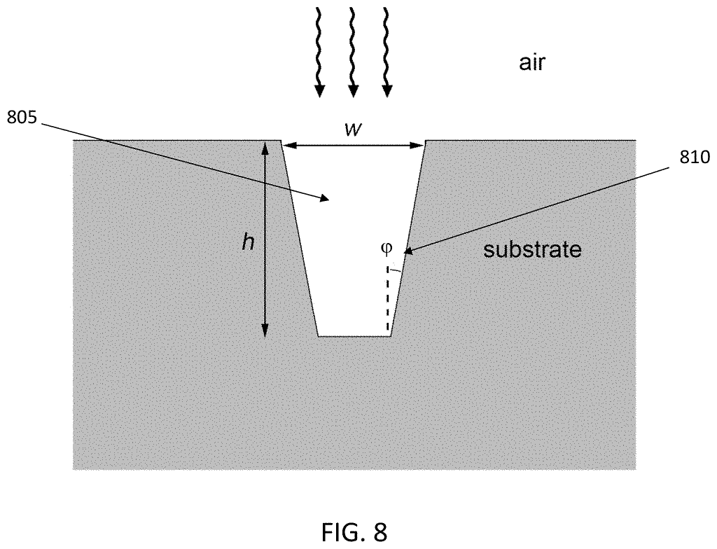

Exemplary structures are illustrated in FIGS. 7-8. FIG. 7 illustrates a cylindrical scatterer (705). This scatterer (705) can be an empty gap (empty scatterer) or filled with nanoparticles. This scatterer (705) is also referred to as three dimensional scatterer. The substrate comprises an array of such scatterers. The scatterer (705) has a cylindrical shape with a height h and a width w. FIG. 8 illustrates a truncated cone scatterer (805). The scatterer (805) can be an empty gap, or filled with nanoparticles. The substrate comprises an array of such scatterers. The scatterer (805) has a truncated cone shape with a height h, a width w, and a sidewall angle φ (810).

For structures comprising nanoparticles, the nanoparticles were assumed to be spheres of diameter, d. The particles were assumed to be distributed in a conformal manner on the sidewalls and bottom of the structure (for the conformal case), or else completely filling the gaps in the structure (for the planar case). Nanoparticle diameters of 30, 60, 135, and 300 nm were considered. In the actual fabrication of composite structures, different nanoparticles may be used, having diameters other than those listed above and combinations of different diameters in the same or different layers. Generally, nanoparticles may have a size in the nanometer range, for example, 20-400 nm, or 1-900 nm.

For larger diameter nanoparticles, there are cases where only one to two particles span the width of the gaps in the structure. For these embodiments, the conformal and planar cases may be the same. In some embodiments, the nanoparticles have a refractive index of between 1.5 (e.g. SiO₂) and 2 (e.g. TiO₂). In the following, the interpretation of scattering cross sections is discussed.

Considering a random distribution of scatterers, each with a scattering cross section a, and a total surface density of γ scatterers per unit area, the transmission haze can be calculated as:

haze=(1−e^{-γσ})×100%

As an example, if a surface has a typical, or average, center-to-center distance of 1 μm between scatterers, then γ=10⁸ cm⁻². If the scattering cross section of each individual scatterer is σ=10⁻⁸ cm² at a given wavelength, then the haze at that wavelength is approximately 63%. If instead σ=10⁻⁹ cm², the then haze can be calculated to be about 10%. As another example, if σ=10⁻¹⁰ cm², the then haze is can be calculated to be about 1%.

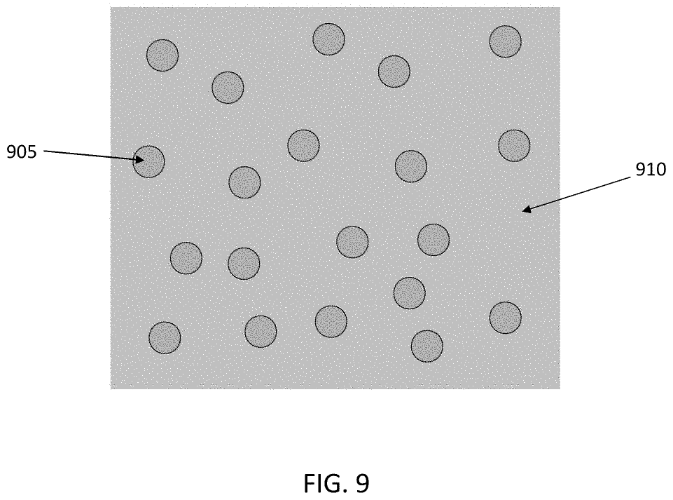

As a rule of thumb, then, for scatterers of a given density γ, a scattering cross section of σ of about 1/γ will yield a significantly hazy surface, but a reduction of σ by an order of magnitude or more will significantly reduce the haze. FIG. 9 illustrates a top-down view of randomly distributed scattering structures on a surface. These structures could be, for example, cylindrical scatterers (905) etched in a glass substrate (910).

For structures with no sidewall angle, the addition of a conformal layer of SiO₂ nanoparticles with a 30 nm diameter reduces the scattering cross section of the substrate. At an incident wavelength λ=550 nm, the reduction in the scattering cross section is greatest for narrow structures, and minimal for wider structures. For narrower structures, the 30 nm nanoparticles nearly fill the etched gaps in the substrate.

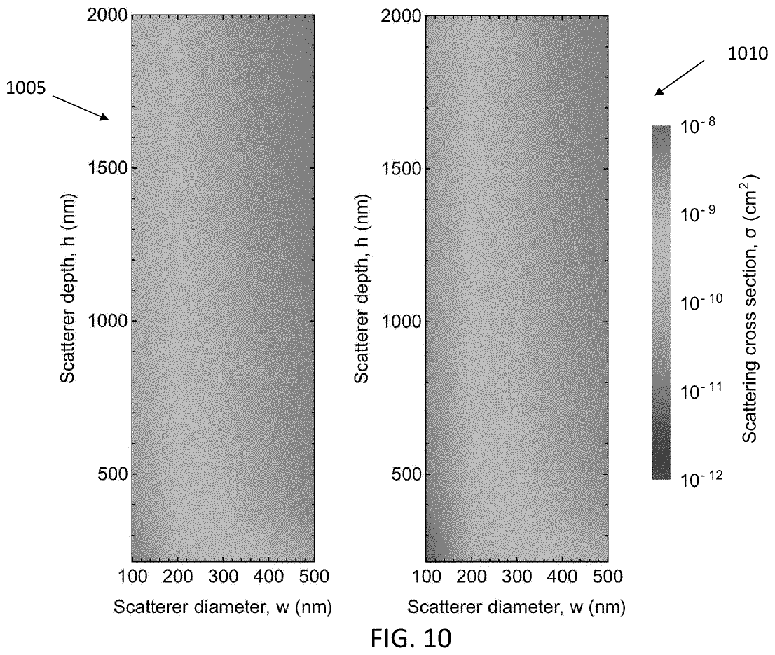

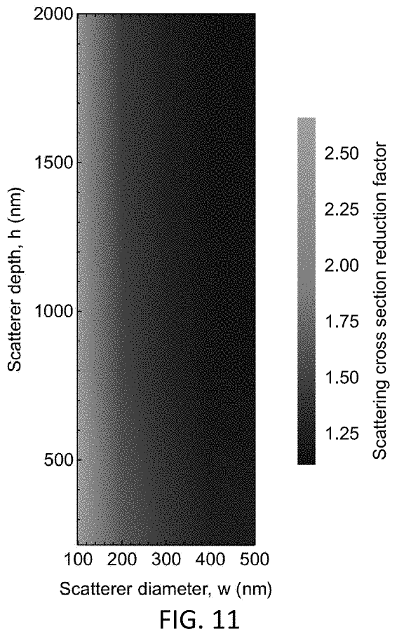

FIG. 10 illustrates the scattering cross section σ at λ=550 nm with no sidewall angle and no nanoparticles (1005), and σ at λ=550 nm with 30 nm conformal nanoparticles (1010). The scatterer depth or height h is on the y axis, while the scatterer diameter w is on the x axis. The cross section decreases in a gradient from right to left of the figure, for both (1005) and (1010). FIG. 11 illustrates improvement in scattering cross section for FIG. 10, comparing the structures with (1010) and without nanoparticles (1005).

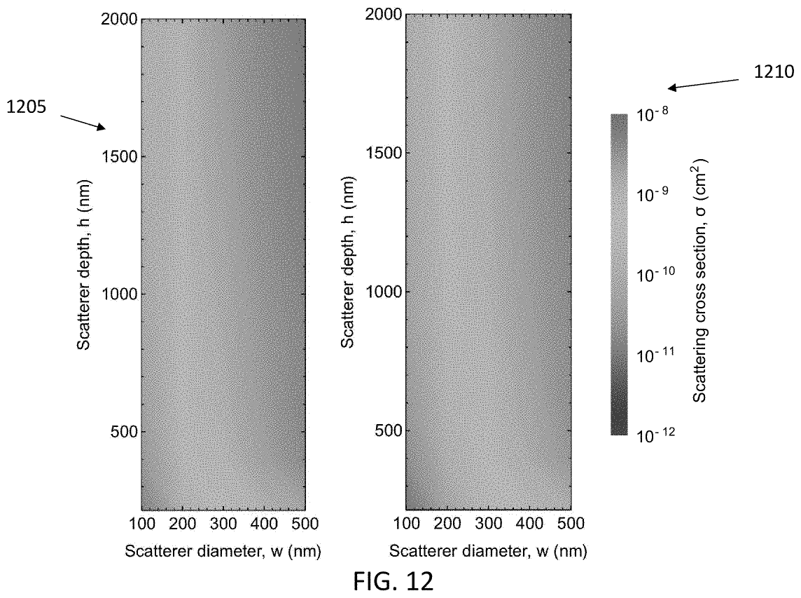

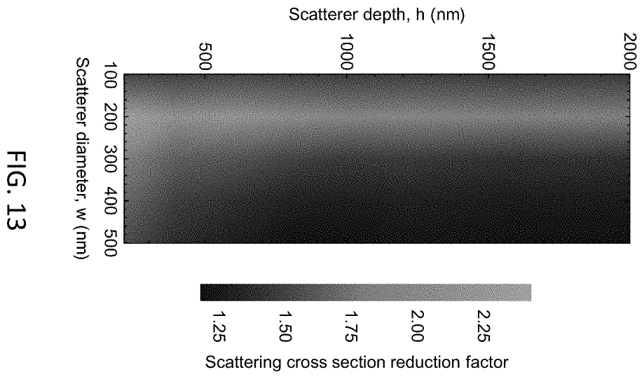

As illustrated in FIG. 12, for structures with no sidewall angle and no nanoparticles (1205), the addition of a conformal layer of SiO₂ nanoparticles with a 60 nm diameter reduces the scattering cross section the most for structures with a width close to 200 nm (1210). FIG. 12 illustrates σ at λ=550 nm with no sidewall angle (1205), and σ at λ=550 nm with a conformal layer of 60 nm nanoparticles (1210). The cross section decreases in a gradient from right to left of the figure, for both (1205) and (1210). This effect can be explained by observing that the nanoparticles nearly fill the gaps with a width near 200 nm, thereby reducing the scattering effect of the etched gaps. FIG. 13 illustrates improvement in scattering cross section for FIG. 12, comparing the structures with no sidewall angle and no nanoparticles (1205), and structures with the addition of a conformal layer of SiO₂ nanoparticles with a 60 nm diameter (1210).

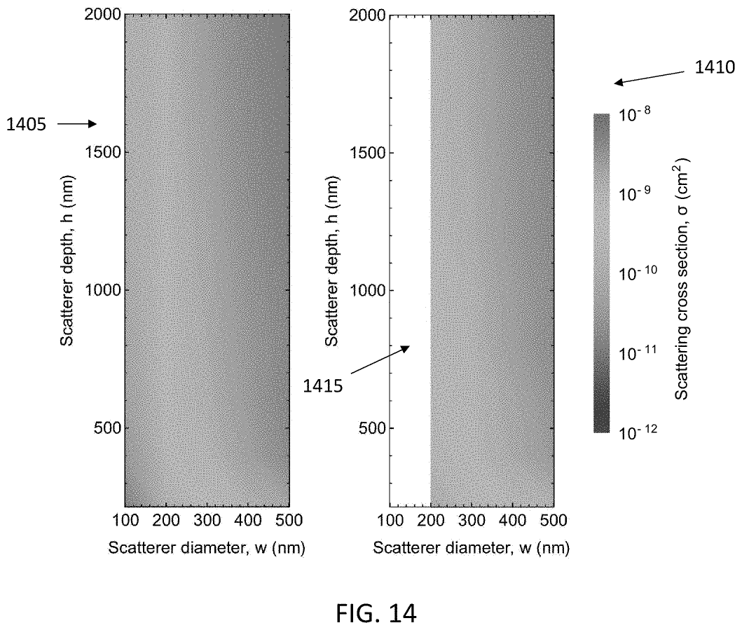

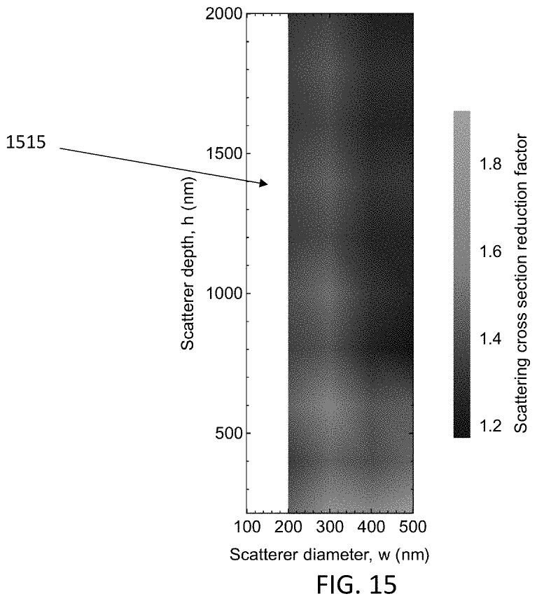

As illustrated in FIG. 14, for structures with no sidewall angle, the addition of a conformal layer of SiO₂ nanoparticles with a diameter of 135 nm reduces the scattering cross section the most for structures with a width near 300 nm. FIG. 14 illustrates σ at λ=550 nm with no sidewall angle (1405), and σ at λ=550 nm with a conformal layer of 135 nm nanoparticles (1410). The cross section decreases in a gradient from right to left of the figure, for both (1405) and (1410). This effect can be explained by observing that the nanoparticles nearly fill the gaps with a width near 300 nm, thereby reducing the scattering effect of the etched gaps. Since the nanoparticles cannot fit into gaps with a width below the nanoparticle diameter, a region of the parameter space in FIG. 14 is blank (1415). FIG. 15 illustrates improvement in scattering cross section for FIG. 14, comparing the structures with no sidewall angle (1405) and structures with a conformal layer of 135 nm nanoparticles (1410). Due to a blank space (1415) in FIG. 14, a blank space (1515) is also present in FIG. 15.

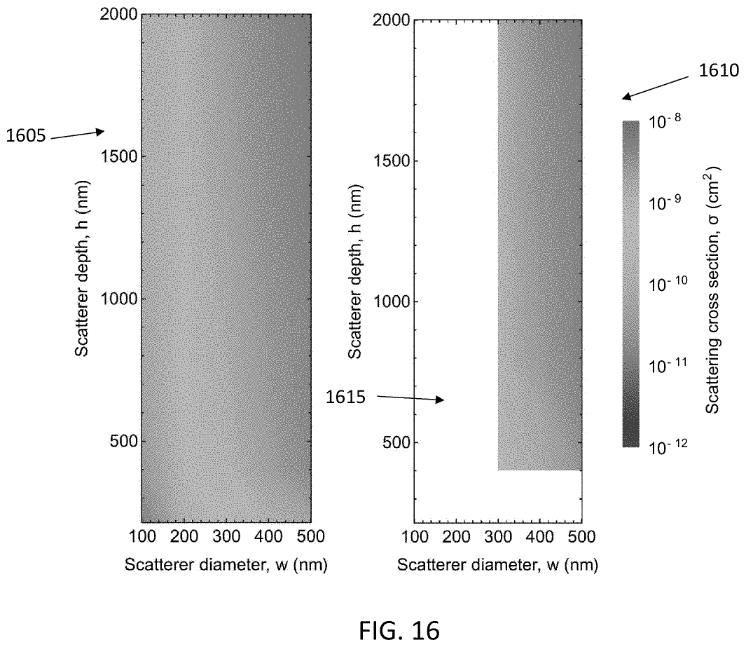

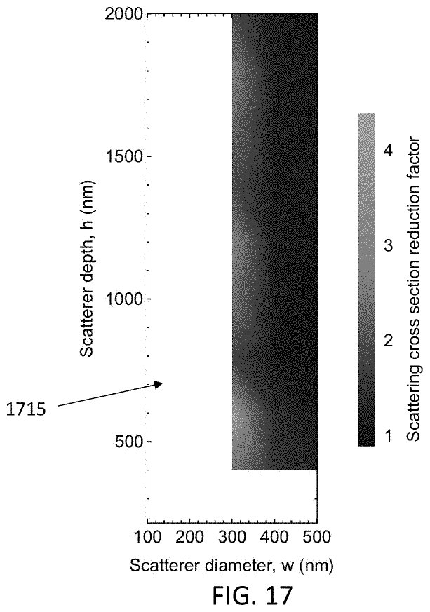

As illustrated in FIG. 16, for structures with no sidewall angle (1605), the addition of a conformal layer of SiO₂ nanoparticles with a diameter of 300 nm reduces the scattering cross section the most for structures with a width near 300 nm. FIG. 16 illustrates σ at λ=550 nm with no sidewall angle (1605), and σ at λ=550 nm with a conformal layer of 300 nm nanoparticles (1610). The cross section decreases in a gradient from right to left of the figure, for both (1605) and (1610). This effect can be explained by observing that the nanoparticles nearly fill the gaps with a width near 300 nm, thereby reducing the scattering effect of the etched gaps. Since the nanoparticles cannot fit into gaps with a width or height below the nanoparticle diameter, a region of the parameter space in FIG. 16 is blank (1615). FIG. 17 illustrates improvement in scattering cross section for FIG. 16, comparing the structures with no sidewall angle (1605) and structures with a conformal layer of 300 nm nanoparticles (1610). Due to the blank space (1615) in FIG. 16, a blank space (1715) is also present in FIG. 17.

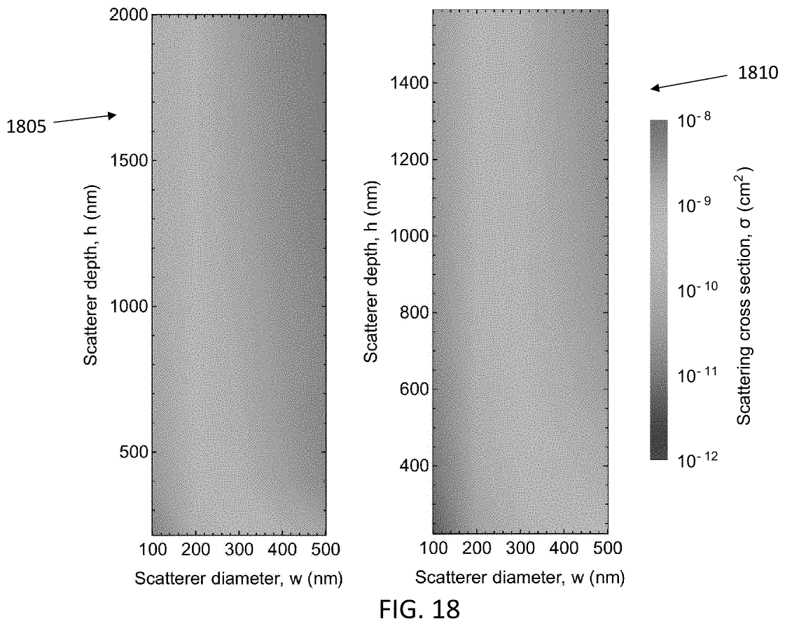

As illustrated in FIG. 18, for structures with no sidewall angle (1805), the addition of one or more layers according to the planar configuration of FIG. 6, one or more layers of SiO₂ nanoparticles with a diameter of 30 nm completely filling the gaps reduces the scattering cross section more compared to the same structures but with a conformal layer of 30 nm nanoparticles. The effect is still most significant for narrower structures. A more pronounced height dependence in the scattering cross section can also be noted.

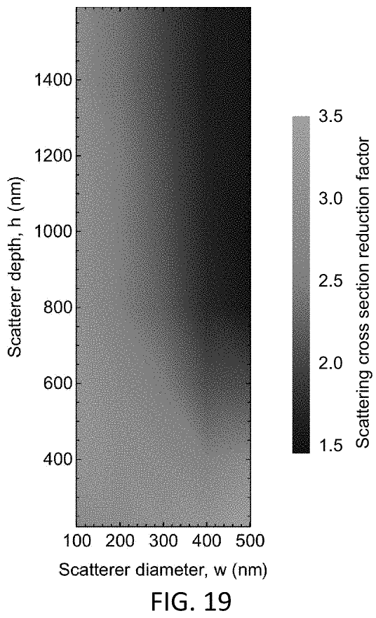

FIG. 18 illustrates σ at λ=550 nm with no sidewall angle (1805), and σ at λ=550 nm with one or more planar layers of 30 nm nanoparticles (1810). The cross section decreases in a gradient from right to left of the figure, for both (1805) and (1810). FIG. 19 illustrates improvement in scattering cross section for FIG. 18, comparing the structures with no sidewall angle (1805) and structures with one or more planar layers of 30 nm nanoparticles (1810).

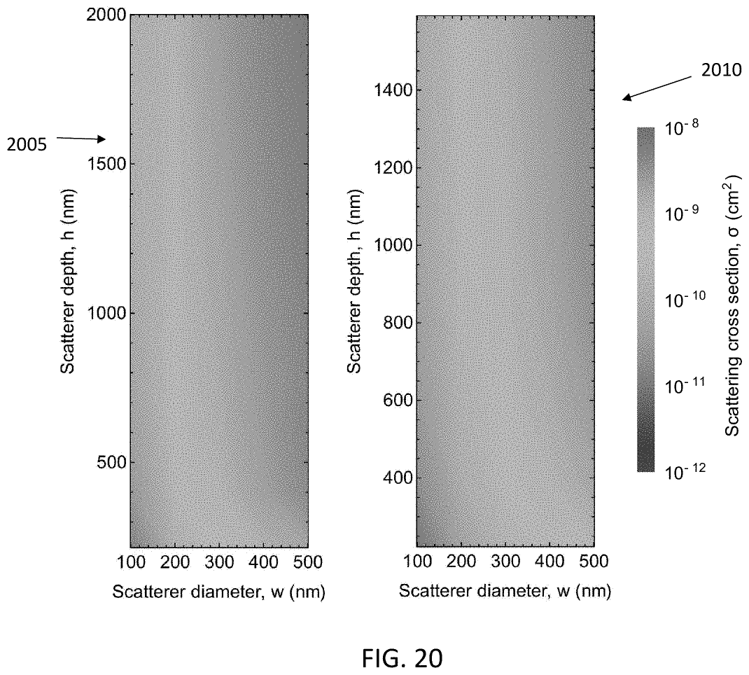

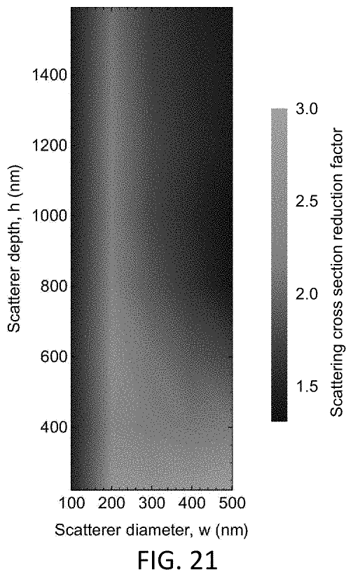

As illustrated in FIG. 20, for structures with no sidewall angle, the addition of one or more layers of SiO₂ nanoparticles with a diameter of 60 nm in a planar configuration (completely filling the gaps) reduces the scattering cross section the most for structures with a diameter near 200 nm. FIG. 20 illustrates σ at λ=550 nm with no sidewall angle (2005), and σ at λ=550 nm with planar layers of 60 nm nanoparticles (2010). The cross section decreases in a gradient from right to left of the figure, for both (2005) and (2010). The effect is more pronounced for structures having a diameter of 200 nm. Completely filling the gaps reduces the scattering cross section more compared to the same structures but with a conformal layer of 60 nm nanoparticles. A more pronounced height dependence in the scattering cross section can also be noted. FIG. 21 illustrates the factor of improvement in scattering cross section for FIG. 20, comparing the structures with no sidewall angle (2005) and structures with planar layers of 60 nm nanoparticles (2010).

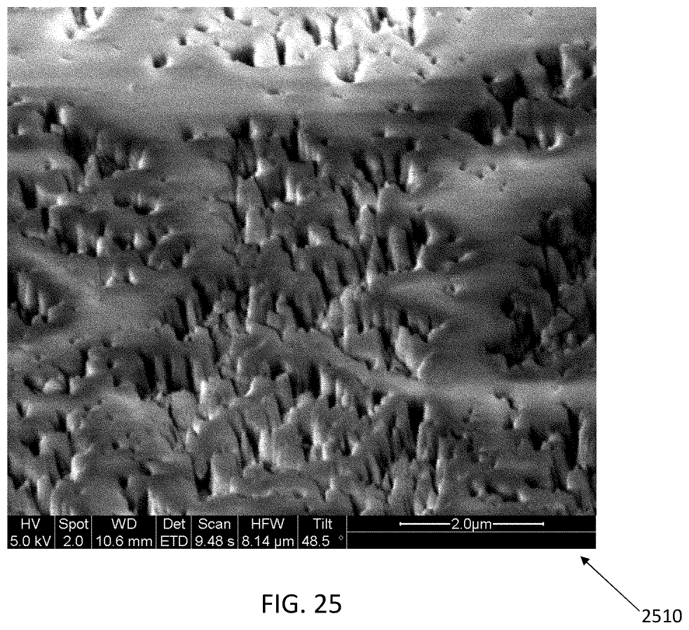

FIG. 25 illustrates an exemplary SEM picture of substrate features with pits and with pits having pillars that protrude from the bottom of the pits (2510).

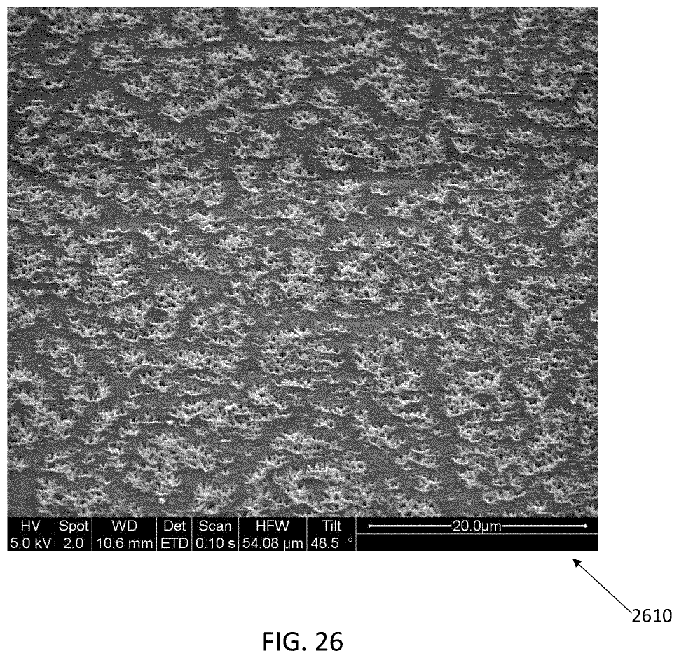

FIG. 26 illustrates an exemplary zoomed out SEM picture of substrate features with pits and with pits having pillars that protrude from the bottom of the pits (2610).

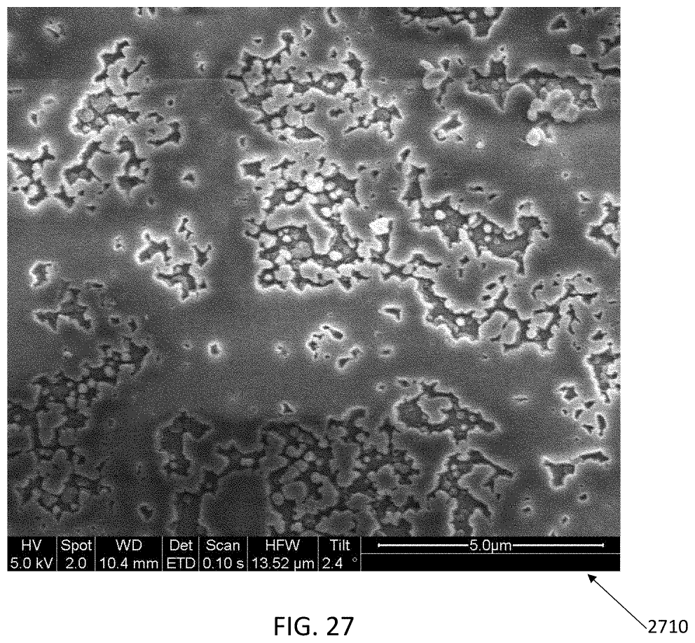

FIG. 27 illustrates an exemplary top-down SEM picture of substrate features having pits only (2710). The pits appear as irregular shapes, similar to a lake.

In some embodiments, the transparency of the composite material is optimized for the visible light spectrum. Visible light is generally considered in the range from approximately 400 nm to approximately 700 nm. In some embodiments, the three dimensional structures on the substrate are an array of pillars, whether periodic or irregular. The pillars may have a shape selected from the group consisting of: cylindrical, truncated cone, parallelepipedal, ellipsoidal, jagged. The jagged structures are irregularly shaped due to the fabrication process. These pillars can be etched onto the substrate, for example through a nanoparticle mask. In these embodiments, the nanoparticles fill the spaces between pillars, either partially or entirely, and may also be attached on the sides of the pillars. In other embodiments, the three dimensional structures are instead etched as gaps, or empty spaces, in the substrate. In these embodiments, the nanoparticles fill these gaps either completely or partially. The gaps can also be referred to as voids, empty spaces, or scatterers. Additionally, nanoparticles can also cover the upper surface of the substrate, above the level of the gaps. In some embodiments, the nanoparticles forming the mask may be superhydrophobic or superhydrophilic. In some embodiments, the features are etched in the substrate based on the nanoparticle mask, however no nanoparticles are subsequently deposited to fill, completely or partially, the empty spaces between features. In these embodiments, the fact that the mask remains on the substrate and is superhydrophobic or superhydrophilic can impart additional functionalities to the substrate. In some embodiments, the nanoparticles have an average diameter of between 20 and 400 nm. In some embodiments, the nanoparticles and the substrate are configured to reduce haze or scattering of the incident light.

In some embodiments, the features on a substrate do not need to be completely filled to observe a beneficial optical effect. Two limiting cases can be instructively defined as conformal (one perfect layer of NP) or planar (completely filling the gaps between features). However, some embodiments can fall between these two limiting examples with intermediate effects. Several parameters can influence the haze reduction of a structure, such as the shape of the features, the sidewall angle, the ratio of nanoparticle size to feature size (both width and height), and the nanoparticle index of refraction.

In some embodiments, a structure according to the present disclosure can be fabricated with the following process: 1 mg/mL 135 nm Al₂O₃ to 0.5 mg/mL of 30 nm SiO₂ nanoparticles are added in 190 proof ethanol (giving a 2:1 ratio of NPs); the suspension is sonicated, then sprayed on a substrate with a flow rate of 0.5 ml/min. The spray can be repeated 4 or 8 times. The shaping gas can be adjusted to a pressure of 1.5 psi. In other embodiments, an exemplary pressure is 0.88 psi. In some embodiments, the wavelength range in which the substrate is transparent is between 400 nm and 700 nm. In other embodiments, other wavelength ranges may be used, also outside the visible spectrum.

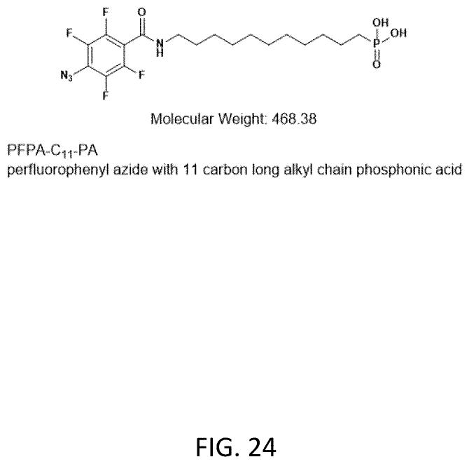

In some embodiments, the masking material for the etching process utilizes the following procedure. A glass surface (soda-lime, or borosilicate, or any other SiO₂-based glass) was cleaned with soapy water and thoroughly rinsed with deionized (DI) water before being dried with a stream of nitrogen. The material to be coated and patterned with these nanoparticles does not need to be glass. The cleaned glass was subjected to thermal atomic layer deposition (ALD) deposition of 10 nanometers (nm) of Al₂O₃. The ALD thin film of Al₂O₃ was freshly activated with an oxygen-based plasma at 100 mTorr pressure for 10 minutes to provide an AlOₓ surface. Other types of thermal and plasma ALD films, such as TiO2 and others, may be used for this procedure. The freshly oxidized thin film of alumina on top of glass was dipped into an isopropyl alcohol (IPA) solution of PFPA-C₁₁-PA (2 micro Molar, 2 μM). FIG. 24 illustrates a chemical structure for PFPA-C₁₁-PA. The glass was allowed to soak in the solution of phosphonic acid for 12 to 72 hours before it was removed and rinsed with a wash bottle stream of IPA, and then dried with a stream of nitrogen gas to give a self-assembled monolayer (SAM) of PFPA-phosphonic acid on top of the ALD surface. The water contact angles (WCA) changed during the process, it was approximately 20 degrees prior to oxygen-based plasma and then changed to 0 degrees. The WCA changed again from 0 to 80 degrees after the dip in IPA solution of phosphonic acid. The freshly prepared SAM of PFPA-PA was subjected to neat commercially available branched polyethyleneimine (PEI, Sigma-Aldrich, MW=800) and spread evenly over the glass surface using a microscope slide to give a thin film (excess, microns thick layer) of PEI on top of the PFPA-PA SAM. This sample was subjected to an LED light bulb at 365 nm with a power setting of 26 milliwatts/cm² for 10 minutes. The excess polymer PEI was rinsed off using copious amounts of IPA, then ethanol and finally DI water. The freshly rinsed surface had a WCA of 15 degrees. The sample was placed in a freshly sonicated (15 minutes) colloidal suspension of amorphous SiO₂ nanoparticles (NPs, US Nano, 60-70 nm) in DI water (10 mg/mL) for 2 hours. The excess NPs were rinsed off using IPA, EtOH, and finally water.

The silicon dioxide nanoparticles in the preceding procedure may be substituted by other nanoparticles, such as ZrO₂, Y₂O₃, AlN, or Ta₂O₅. These alternative nanoparticles may require a thin silica shell or other type of coating in order to be compatible with this procedure.

It will be understood by those skilled in the art that the approaches disclosed in the present disclosure may be used to increase scatter rather than decrease scatter. The increase in scatter can be achieved, for example, by selecting larger sizes for the nanoparticles such that the nanoparticles are not sub-wavelength and/or by selecting materials for nanoparticles with different refractive index. The increase in scatter will result in reduction of the optical transmission of the substrate.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A structure comprising:
a substrate transparent to electromagnetic radiation within a wavelength range, the substrate comprising a plurality of three dimensional structures and having a first refractive index; and
a plurality of nanoparticles on the substrate, the plurality of nanoparticles having a second refractive index, wherein the plurality of nanoparticles is configured to reduce or to increase scattering of light transmitted through or from the substrate.

2. The structure of claim 1, wherein the plurality of nanoparticles is configured to block infrared radiation.

3. The structure of claim 1, wherein the plurality of nanoparticles in configured to absorb infrared radiation.

4. The structure of claim 1, wherein the plurality of nanoparticles is configured to emit infrared radiation.

5. The structure of claim 1, wherein the second refractive index is equal to or higher than the first refractive index.

6. The structure of claim 1, wherein the plurality of three dimensional structures comprises an array of pillars having empty spaces, and wherein the plurality of nanoparticles partially or completely fills the empty spaces in the array of pillars.

7. The structure of claim 1, wherein the plurality of three dimensional structures comprises an array of pits or recesses.

8. The structure of claim 6, wherein the array of pillars has a periodic spacing between pillars.

9. The structure of claim 6, wherein the pillars in the array of pillars have a shape selected from the group consisting of: cylindrical, truncated cone, parallelepipedal, ellipsoidal, and jagged.

10. The structure of claim 1, wherein the plurality of three dimensional structures comprises an array of empty scatterers, and the plurality of nanoparticles partially or completely fills each of the empty scatterers.

11. The structure of claim 1, further comprising an adhesive polymer between the substrate and the plurality of nanoparticles, and/or between the three dimensional structures and the plurality of nanoparticles.

12. The structure of claim 1, wherein the plurality of nanoparticles is made of a material selected from the group consisting of: SiO₂, TiO₂, ZrO₂, Y₂O₃, AlN, and Ta₂O₅.

13. The structure of claim 1, further comprising a hydrophobic polymer on the plurality of nanoparticles.

14. The structure of claim 13, wherein the plurality of nanoparticles is made of or coated with a hydrophobic material.

15. The structure of claim 2, wherein the plasmonic nanoparticles are made of a material selected from the group consisting of: antimony tin oxide, indium tin oxide, aluminum zinc oxide, silver, gold, and aluminum.

16. The structure of claim 15, wherein the empty scatterers in the array of empty scatterers have a shape selected from the group consisting of: cylindrical, truncated cone, parallelepipedal, ellipsoidal, jagged, and their inverses.

17. The structure of claim 6, wherein the plurality of nanoparticles is completely filling the empty spaces in the array of pillars.

18. The structure of claim 10, wherein the plurality of nanoparticles is completely filling the empty scatterers.

19. The structure of claim 1, wherein the plurality of nanoparticles has an average diameter between 20 and 400 nm.

20. The structure of claim 2, wherein the plurality of nanoparticles comprises plasmonic nanoparticles.

21. The structure of claim 1, wherein a wavelength of light ranges between 400 nm and 700 nm.

22. A structure comprising:
a substrate transparent to electromagnetic radiation within a wavelength range, the substrate comprising a plurality of three dimensional structures and having a first refractive index; and
a coating on the substrate, the coating having a second refractive index or effective refractive index, wherein the coating is configured to reduce or to increase the scattering of light transmitted through or from the substrate.

23. The structure of claim 22, wherein the coating is a composite of multiple materials.

24. The structure of claim 23, wherein the composite contains nanoparticles.

25. The structure of claim 22, wherein the coating is inherently superhydrophilic, superhydrophobic, or oleophobic.

26. A method comprising:
providing a substrate transparent to electromagnetic radiation within a wavelength range, the substrate having a first refractive index;
depositing a first plurality of nanoparticles on the substrate in a pattern; and
etching a plurality of three dimensional scatterers on the substrate using the first plurality of nanoparticles as a mask.

27. The method of claim 26, further comprising:
selecting a material for a second plurality of nanoparticles having a second refractive index, the second refractive index being equal to or higher than the first refractive index; and
depositing at least one layer of the second plurality of nanoparticles on the substrate, the depositing comprising partially or completely filling empty spaces in the substrate, thereby reducing scattering of the electromagnetic radiation.

28. A method comprising:
providing a substrate transparent to electromagnetic radiation within a wavelength range, the substrate comprising a plurality of three dimensional scatterers and having a first refractive index;
selecting a material for a first plurality of nanoparticles having a second refractive index, the second refractive index being equal to or higher than the first refractive index; and
depositing at least one layer of the first plurality of nanoparticles on the substrate, the depositing comprising partial or complete filling of empty spaces in the substrate, thereby reducing or increasing scattering of the electromagnetic radiation.

29. The method of claim 28, wherein depositing at least one layer of the first plurality of nanoparticles on the substrate further comprises:
a) contacting the substrate to a first solution comprising an adhesive polymer and a first solvent, thereby chemisorbing the adhesive polymer to the substrate;
b) rinsing the substrate with a second solvent, thereby washing off loosely adhering adhesive polymer;
c) contacting the substrate coated with the adhesive polymer with a second solution comprising nanoparticles and a third solvent; and
d) rinsing the substrate coated with the adhesive polymer and nanoparticles with a fourth solvent, thereby washing off loosely adhering nanoparticles.

30. The method of claim 29, further comprising iterating steps a)-d).

31. The method of claim 29, wherein the adhesive polymer is polyvinyl pyrrolidone, and the first, second, third, and fourth solvents are selected from the group consisting of: ethanol, water, methyl ethyl ketone, and mixtures thereof.
